(19) United States
(12) Patent Application Publication
(10) Pub. No.: US 2026/0119009 A1
(43) Pub. Date: Apr. 30, 2026

(54) PAGE DISPLAY METHOD, APPARATUS, READABLE MEDIUM, ELECTRONIC DEVICE, AND PROGRAM PRODUCT

(71) Applicant: Beijing Youzhuju Network Technology Co., Ltd., Beijing (CN)

(72) Inventors: Xin DING, Beijing (CN); Xinle LIU, Beijing (CN); Shaoyuan ZHU, Beijing (CN); Di PAN, Beijing (CN); Yixin HOU, Beijing (CN); Xin WU, Beijing (CN); Chao XUE, Beijing (CN); Xiaomin SONG, Beijing (CN)

(21) Appl. No.: 19/368,092

(22) Filed: Oct. 24, 2025

(30) Foreign Application Priority Data
Oct. 31, 2024 (CN) 202411548538.6

(51) Int. Cl. G06F 3/0483; G06F 3/04842

(52) U.S. Cl. CPC G06F 3/0483; G06F 3/04842

(57) ABSTRACT

A page display method and apparatus, a readable medium, an electronic device, and a program product are provided. The method includes: displaying an identification of an intelligent object on a page, the identification of the intelligent object being used to trigger an intelligent object page, the intelligent object page being at least used to provide an auxiliary function associated with the page; displaying a first intelligent object page in response to a first trigger operation on the identification of the intelligent object on the page; and displaying a second intelligent object page in response to a second trigger operation on the identification of the intelligent object on the page, where display content of the first intelligent object page and display content of the second intelligent object page are different.

### CROSS-REFERENCE TO RELATED APPLICATION

This application claims the priority to and benefits of the Chinese Patent Application, No. 202411548538.6, which was filed on Oct. 31, 2024. The aforementioned patent application is hereby incorporated by reference in its entirety.

### TECHNICAL FIELD

The present disclosure relates to the field of computer technologies, and specifically, to a page display method and apparatus, a readable medium, an electronic device, and a program product.

### BACKGROUND

With the development of intelligent technologies, intelligent objects are more and more widely applied in various fields, for example, content delivery, data analysis, video creation, and other fields, to help users solve various problems they encounter.

However, in the related art, after an intelligent object page of an intelligent object is triggered, display content in the intelligent object page is relatively unitary, and there is great limitation in the using process.

### SUMMARY

This Summary is provided to introduce concepts in a simplified form that are described in detail in the following Detailed Description. This Summary is not intended to identify key features or necessary features of the claimed technical solution, nor is it intended to be used to limit the scope of the claimed technical solution.

In a first aspect, the present disclosure provides a page display method, the page display method including: displaying an identification of an intelligent object on a page, the identification of the intelligent object being used to trigger an intelligent object page, the intelligent object page being at least used to provide an auxiliary function associated with the page by the intelligent object; displaying a first intelligent object page in response to a first trigger operation on the identification of the intelligent object on the page; and displaying a second intelligent object page in response to a second trigger operation on the identification of the intelligent object on the page, where display content of the first intelligent object page and display content of the second intelligent object page are different.

In a second aspect, the present disclosure provides a page display apparatus, the page display apparatus including: a first display module configured to display an identification of an intelligent object on a page, the identification of the intelligent object being used to trigger an intelligent object page, the intelligent object page being at least used to provide an auxiliary function associated with the page by the intelligent object; a second display module configured to display a first intelligent object page in response to a first trigger operation on the identification of the intelligent object on the page; and a third display module configured to display a second intelligent object page in response to a second trigger operation on the identification of the intelligent object on the page, where display content of the first intelligent object page and display content of the second intelligent object page are different.

In a third aspect, the present disclosure provides a computer-readable medium having a computer program stored thereon, where the computer program, when executed by a processing apparatus, performs the steps of the method according to the first aspect.

In a fourth aspect, the present disclosure provides an electronic device, including: a storage apparatus having a computer program stored thereon; and a processing apparatus configured to execute the computer program in the storage apparatus to implement the steps of the method according to the first aspect.

In a fifth aspect, the present disclosure provides a computer program product, including a computer program, where the computer program, when executed by a processor, implements the steps of the method according to the first aspect.

With above technical solutions, it is possible to display the identification of the intelligent object on the page, and in response to different trigger operations on the identification of the intelligent object on the page, the intelligent object page may be displayed, and different display content may be displayed in the intelligent object page. Thus, the display content in the intelligent object page may be changed according to different trigger operations, to implement personalized scene adaptation, satisfy the needs of users in different scenes, and improve interaction efficiency and user experience. In addition, since the intelligent object page may also be used to provide the auxiliary function associated with the page, on one hand, the display content in the intelligent object page may be enriched, and on the other hand, the problem on the page may be quickly solved through the auxiliary function without frequent interaction with the intelligent object, thereby further improving interaction efficiency and user experience.

Other features and advantages of the present disclosure will be described in detail in the following detailed description.

### BRIEF DESCRIPTION OF DRAWINGS

The above and other features, advantages, and aspects of embodiments of the present disclosure will become more apparent when taken in conjunction with the drawings and with reference to the following detailed description. Throughout the drawings, the same or similar reference numerals represent the same or similar elements. It should be understood that the drawings are schematic and that parts and elements are not necessarily drawn to scale. In the drawings:

FIG. 1 is a flowchart of a page display method according to an exemplary embodiment of the present disclosure;

FIG. 2 is a schematic diagram of a first intelligent object page according to an exemplary embodiment of the present disclosure;

FIG. 3 is a schematic diagram of a second intelligent object page according to an exemplary embodiment of the present disclosure;

FIG. 4 is a schematic diagram of creating a new conversation with an intelligent object according to an exemplary embodiment of the present disclosure;

FIG. 5 is a schematic diagram of triggering and displaying historical conversation content with an intelligent object according to an exemplary embodiment of the present disclosure;

FIG. 6 is a schematic diagram of triggering and displaying historical conversation content according to an exemplary embodiment of the present disclosure;

FIG. 7 is a schematic diagram of triggering and displaying historical conversation content with an intelligent object and a human customer service agent according to an exemplary embodiment of the present disclosure;

FIG. 8 is a schematic diagram of triggering and displaying function introduction information and/or operation tutorial information of an intelligent object according to an exemplary embodiment of the present disclosure;

FIG. 9 is a block diagram of a structure of a page display apparatus according to an exemplary embodiment of the present disclosure; and

FIG. 10 is a schematic diagram of a structure of an electronic device according to an exemplary embodiment of the present disclosure.

### DETAILED DESCRIPTION

Embodiments of the present disclosure will be described in more detail below with reference to the drawings. While some embodiments of the present disclosure are shown in the drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are only for illustrative purposes and are not intended to limit the protection scope of the present disclosure.

It should be understood that various steps described in method implementations of the present disclosure may be performed in different order and/or in parallel. In addition, method implementations may include additional steps and/or omit performing illustrated steps. The scope of the present disclosure is not limited in this respect.

As used herein, the term “include/comprise” and variations thereof are open-ended inclusions, that is, “include/comprise but not limited to”. The term “based on” is “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that concepts such as “first” and “second” mentioned in the present disclosure are only used to distinguish different apparatuses, modules or units, and are not used to limit the order or interdependence of functions performed by these apparatuses, modules or units.

It should be noted that the modifications of “one” and “more” mentioned in the present disclosure are illustrative rather than restrictive, and those skilled in the art should understand that they should be understood as “one or more” unless the context clearly indicates otherwise.

Names of messages or information exchanged between apparatuses in implementations of the present disclosure are only used for illustrative purposes, and are not used to limit the scope of these messages or information.

It should be understood that before the technical solutions disclosed in the embodiments of the present disclosure are used, users should be informed of the type, use scope, use scene, etc, of personal information involved in the present disclosure through appropriate ways in accordance with relevant laws and regulations, and the authorization of users should be obtained.

For example, in response to receiving an active request from a user, prompt information is sent to the user to explicitly prompt the user that the operation requested to be performed will require the acquisition and use of the user's personal information. Thus, the user can independently select whether to provide personal information to software or hardware such as an electronic device, an application, a server, or a storage medium that performs an operation of the technical solution of the present disclosure according to the prompt information.

As an optional but non-limiting implementation, in response to receiving an active request from a user, the prompt information is sent to the user in the form of a pop-up window, and the prompt information may be presented in text in the pop-up window. In addition, the pop-up window may carry a selection control for the user to select “agree” or “disagree” to provide personal information to the electronic device.

It should be understood that above processes of notifying and obtaining user authorization are only illustrative, and do not constitute a limitation on implementations of the present disclosure. Other methods that meet relevant laws and regulations can also be applied to implementations of the present disclosure.

At the same time, it should be understood that the data involved in the technical solutions (including, but not limited to, the data itself, the acquisition or use of the data) shall comply with the requirements of corresponding laws, regulations and related provisions.

As mentioned in the Background section, intelligent objects may be used in different fields, for example, may be arranged on a page in an embedded manner, so that when an intelligent object is triggered, an intelligent object page may be displayed, and then the user may interact with the intelligent object through the intelligent object page to solve various problems encountered by the user on the page.

However, in the related art, the display content on the intelligent object page is relatively unitary, and generally only input controls for interacting with the intelligent object, such as a text input box, are displayed. Thus, when solving a problem through the intelligent object, it is necessary to frequently use the input controls to interact with the intelligent object, thereby increasing the complexity of interaction.

In addition, since the content displayed on the intelligent object page is consistent (generally, input controls used to interact with the intelligent object) when the user triggers the intelligent object page on different pages or at entrances of different functional modules, it is impossible to provide personalized assistance according to the specific situation of the user, which on one hand increases the complexity of interaction and on the other hand reduces the interaction efficiency.

In view of this, the present disclosure provides a page display method and apparatus, a readable medium, an electronic device, and a program product to solve above technical problems.

The embodiments of the present disclosure will be further explained and illustrated below with reference to the drawings.

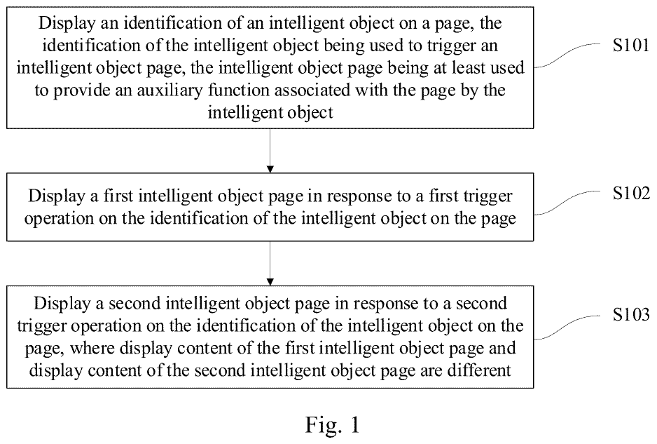

FIG. 1 is a flowchart of a page display method according to an exemplary embodiment of the present disclosure, and referring to FIG. 1, the page display method may include the following steps:

S101: display an identification of an intelligent object on a page, the identification of the intelligent object being used to trigger an intelligent object page, the intelligent object page being at least used to provide an auxiliary function associated with the page by the intelligent object.

In the embodiment, the intelligent object page is a page integrated with the intelligent object, and by the intelligent object page, the user may interact with the integrated intelligent object, for example, have a conversation with the intelligent object. The page may be a content display page in an application, or a content display page in a browser, and of course, other pages are also possible, which is not limited in the embodiment of the present disclosure. Exemplarily, in a content delivery scene, the page may be a page in a content delivery platform for the user to browse, manage, and/or deliver content. For example, it may be a home page that the user sees first after logging in to the content delivery platform, or may be an operation page of different functional modules in the content delivery platform.

In the embodiment, the auxiliary function associated with the page may be used to characterize the function used to solve the problem of the page, which may be determined according to the display content on the page, or may be determined according to the core function of the page, and of course may also be determined according to other content, for example, may be determined according to a tool frequently used by the user on the page, which is not limited in the embodiments of the present disclosure. Exemplarily, when the content delivery platform includes a content generation module and a content delivery module, the intelligent object page in the content generation module may display an auxiliary function related to content generation, such as an auxiliary function such as content optimization and/or content creation. The intelligent object page in the content delivery module may display an auxiliary function related to content delivery, such as an auxiliary function such as content delivery and/or delivery analysis.

In the embodiment, one or more auxiliary functions may be associated with the page, which is not limited in the embodiments of the present disclosure. When multiple auxiliary functions are associated with the page, all auxiliary functions associated with the page may be displayed on the intelligent object page, or some auxiliary functions associated with the page may be displayed on the intelligent object page. When some auxiliary functions associated with the page are displayed on the intelligent object page, the usage frequency of the user for the auxiliary function may be counted periodically, and then the auxiliary function with the usage frequency greater than or equal to a preset usage frequency is displayed on the intelligent object page.

S102: display a first intelligent object page in response to a first trigger operation on the identification of the intelligent object on the page.

In the embodiment, the trigger operation on the identification of the intelligent object may be a click operation on the identification of the intelligent object, or a sliding operation on the identification of the intelligent object, and of course, may also refer to other operations on the identification of the intelligent object, which is not limited in the embodiments of the present disclosure.

S103: display a second intelligent object page in response to a second trigger operation on the identification of the intelligent object on the page, where display content of the first intelligent object page and display content of the second intelligent object page are different.

In the embodiment, the page in S103 and the page in S102 may be the same page or different pages. When the page in S103 and the page in S102 are the same page, when different users trigger to display the intelligent object page, the display content matching the user may be displayed in the intelligent object page according to the operation record and/or the operation habit of the user on the page, so that when different users trigger to display the intelligent object page, the content may be displayed on the intelligent object page in a targeted manner, thereby satisfying the personalized needs of the users, allowing the users to solve problems more conveniently and quickly through the display content on the intelligent object page, and further improving the interaction efficiency and user experience.

When the page in S103 and the page in S102 are different pages, when any user triggers to display the first intelligent object page and the second intelligent object page, the display content associated with the display content and/or the page function on the page may be displayed on the first intelligent object page and the second intelligent object page according to the display content and/or the page function on different pages, so that when the user triggers the intelligent object page to be displayed on different pages, the content may be displayed on the intelligent object page in a targeted manner, so that the display content on the intelligent object page may implement personalized scene adaptation, thereby effectively helping the user to solve the problem on the page or the scene, and further improving the interaction efficiency and user experience.

With above technical solutions, it is possible to display the identification of the intelligent object on the page, and in response to different trigger operations on the identification of the intelligent object on the page, the intelligent object page may be displayed, and different display content may be displayed on the intelligent object page. Thus, the display content on the intelligent object page may be changed according to different trigger operations, to implement personalized scene adaptation, satisfy the needs of users in different scenes, and improve interaction efficiency and user experience. In addition, since the intelligent object page may also be used to provide the auxiliary function associated with the page, on one hand, the display content on the intelligent object page may be enriched, and on the other hand, the problem on the page may be quickly solved through the auxiliary function without frequent interaction with the intelligent object, thereby further improving interaction efficiency and user experience.

To facilitate understanding of the page display method provided by the present disclosure, possible implementations in the present disclosure will be described below.

In a possible implementation, the page may include a first page and a second page, and accordingly, displaying the first intelligent object page in response to the first trigger operation on the identification of the intelligent object on the page may include:
displaying the first intelligent object page in response to the first trigger operation on the identification of the intelligent object on the first page; and
accordingly, displaying the second intelligent object page in response to the second trigger operation on the identification of the intelligent object on the page may include:
displaying the second intelligent object page in response to the second trigger operation on the identification of the intelligent object on the second page.

In the embodiment, the first page and the second page may be operation pages of different functional modules, or may be pages used to display different content in the same functional module, which is not limited in the embodiments of the present disclosure. Exemplarily, the first page may be an operation page of a content generation module in a content delivery platform, and the second page may be an operation page of a content delivery module in the content delivery platform. Alternatively, the first page may be a page used to display content material in the content generation module, and the second page may be a page used to generate content in the content generation module.

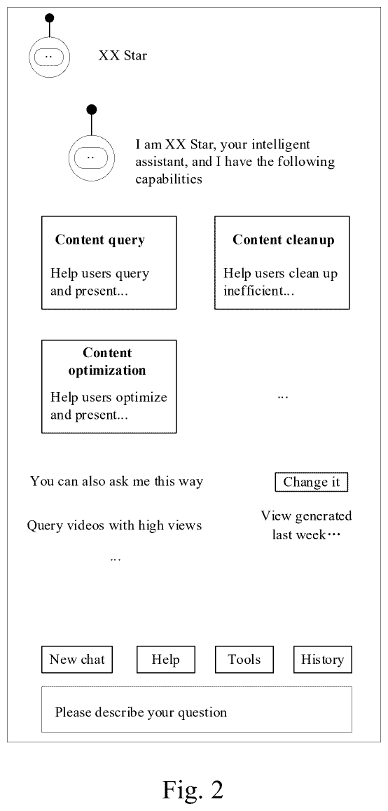

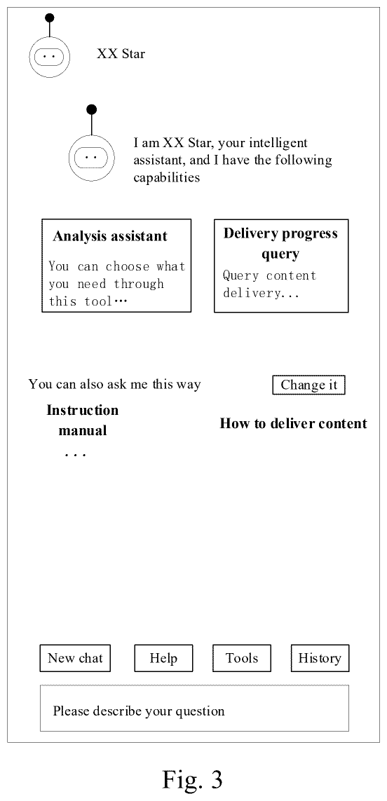

Exemplarily, continuing to refer to the above example, when the content generation module in the content delivery platform is clicked, a content generation page may be displayed, where the identification of the intelligent object is displayed on the content generation page. When the identification of the intelligent object is clicked, the first intelligent object page is displayed, and first content may be displayed on the first intelligent object page, for example, an auxiliary function associated with the content generation page may be displayed on the first intelligent object page, for example, auxiliary functions such as “content query”, “content cleaning” and “content optimization” may be displayed, as shown in FIG. 2. When the content delivery module in the content delivery platform is clicked, a content delivery page may be displayed, where the identification of the intelligent object is displayed on the content delivery page. When the identification of the intelligent object is clicked, the second intelligent object page is displayed, and second content may be displayed on the second intelligent object page, for example, an auxiliary function associated with the content delivery page may be displayed on the second intelligent object page, for example, auxiliary functions such as “analysis assistant” and “delivery progress query” may be displayed, as shown in FIG. 3.

It should be understood that the first content displayed on the first intelligent object page and the second content displayed on the second intelligent object page are only illustrative and do not constitute a limitation on the solution. In a possible implementation, the first content displayed on the first intelligent object page may also be content related to the content generation page, for example, introduction information of functional modules on the content generation page. Similarly, the second content displayed on the second intelligent object page may also be content related to the content delivery page, for example, introduction information of functional modules on the content delivery page.

With above method, when the user triggers to display the intelligent object page on different pages, different content may be displayed on the intelligent object page, so that the display content on the intelligent object page may implement personalized scene adaptation, thereby effectively helping the user to solve the problem on the page or the scene, and further improving the interaction efficiency and user experience.

In a possible implementation, the first intelligent object page is displayed with a first auxiliary function associated with the first page and/or first text information for the user to select, and the second intelligent object page is displayed with a second auxiliary function associated with the second page and/or second text information for the user to select; where the first auxiliary function and the second auxiliary function are different, and/or the first text information and the second text information are different.

Exemplarily, continuing to refer to the above example, first text information may be displayed in an area below the auxiliary function displayed by the first intelligent object page, for example, text information such as “query videos with high views” and/or “view content generated last week” may be displayed, as shown in FIG. 2. Second text information may be displayed in an area below the auxiliary function displayed by the second intelligent object page, for example, text information such as “manual” and/or “how to deliver content” may be displayed, as shown in FIG. 3.

In the embodiment, the text information is a natural language text for the user to have a quick conversation with the intelligent object, the text information may be dynamically changed, or may be fixed, which is not limited in the embodiments of the present disclosure. When the text information is dynamically changed, the conversation content between the user and the intelligent object may be counted and analyzed periodically, and then common problems in the conversation content are extracted and displayed on the intelligent object page in the form of natural language.

With above method, the user may be helped to quickly interact with the intelligent object using the auxiliary function and the text information displayed on the intelligent object page, thereby improving the interaction efficiency between the user and the intelligent object. In addition, since different auxiliary functions and/or text information are displayed on different intelligent object pages, the personalized needs of the user may be met in a targeted manner, allowing the user to solve problems more conveniently and quickly using the auxiliary function and/or text information on the intelligent object page, and further improving the interaction efficiency and user experience.

In a possible implementation, displaying the first intelligent object page in response to the first trigger operation on the identification of the intelligent object on the page may include: displaying the first intelligent object page in response to a first trigger operation of a first user on the identification of the intelligent object on the page; and displaying the second intelligent object page in response to the second trigger operation on the identification of the intelligent object on the page may include: displaying the second intelligent object page in response to a second trigger operation of a second user on the identification of the intelligent object on the page.

Exemplarily, continuing to refer to the above example, the identification of the intelligent object is displayed on the content generation page, and when the user A clicks on the identification of the intelligent object, the intelligent object page is displayed, and auxiliary functions such as “content query” and “content optimization” may be displayed on the intelligent object page. When the user B clicks on the identification of the intelligent object, the intelligent object page is displayed, and auxiliary functions such as “content generation” and “content query” may be displayed on the intelligent object page.

With above method, when different users trigger to display the intelligent object page, different auxiliary functions may be displayed on the intelligent object page, so that the personalized needs of the user may be met in a targeted manner, allowing the user to solve problems more conveniently and quickly using the auxiliary function on the intelligent object page, and further improving the interaction efficiency and user experience.

In a possible implementation, the first intelligent object page and the second intelligent object page are further used to provide a conversation function with the intelligent object, and a first control is displayed on the first intelligent object page and the second intelligent object page, the first control being used to trigger a new conversation with the intelligent object. Accordingly, the page display method may further include:
clearing, on any of the first intelligent object page and the second intelligent object page and in response to a trigger operation on the first control, historical conversation content with the intelligent object, creating a new conversation with the intelligent object, and displaying content that is displayed when a page is initially triggered.

In the embodiment, the conversation function of the intelligent object refers to a function that the intelligent object can understand and generate human languages to communicate and interact with the user. When using the conversation function, the user and the intelligent object may have a conversation in a voice manner, or may have a conversation in a text form, and of course, may also have a conversation in other forms, which is not limited in the embodiments of the present disclosure.

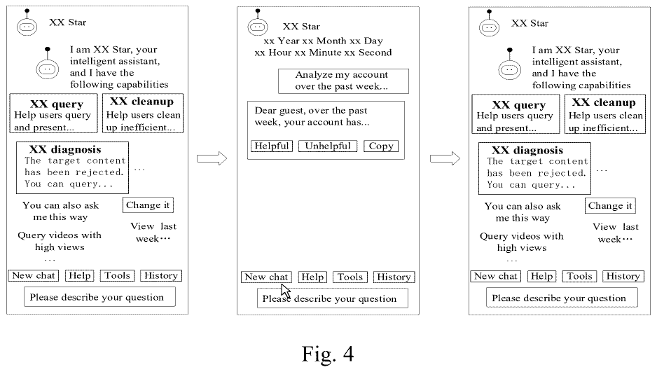

Exemplarily, a text input box for having a conversation with the intelligent object may be displayed in a bottom area of the first intelligent object page, and a first control “new chat” may be displayed above the text input box. After the user inputs conversation content in the text input box, the conversation content may be sent to another display region on the first intelligent object page for display, and the intelligent object may generate corresponding reply content based on the conversation content and display the reply content on the first intelligent object page. When the user triggers the first control “new chat” by clicking or other operations, the conversation content in the first intelligent object page may be cleared, a new conversation with the intelligent object is created, and the display content when the first intelligent object page is triggered for the first time is displayed, as shown in FIG. 4.

It should be understood that triggering a new conversation with the intelligent object by means of the control in this embodiment is only illustrative and does not constitute a limitation on the solution. In a possible implementation, a new conversation with the intelligent object may also be triggered by means of a conversation. For example, a new conversation may be triggered by voice inputting “start a new conversation” or by the user inputting natural language prompt text such as “start a new conversation” in the text input box.

With above method, the first control used to trigger a new conversation with the intelligent object may be displayed on the intelligent object page, and thus by triggering the first control, a new conversation with the intelligent object may be quickly started. In addition, after the first control is triggered, by clearing the historical conversation content, the influence of the historical conversation content on the context understanding of the current conversation may be avoided, thereby ensuring the accuracy and relevance of the new conversation. In addition, after the first control is triggered, by displaying the display content when the intelligent object page is triggered for the first time, a consistent and familiar interaction environment may be provided for the user, which is helpful to reduce the learning cost of the user and enable the user to adapt to the operation manner of the intelligent object more quickly. Furthermore, since the intelligent object page may display the auxiliary function and/or the text information for the user to select when the intelligent object page is triggered for the first time, by re-displaying the initial content after the first control is triggered, the user may be enabled to quickly use the initial content again, thereby improving the interaction efficiency.

In a possible implementation, the first intelligent object page and the second intelligent object page are further used to provide a conversation function with the intelligent object, and a second control is displayed on the first intelligent object page and the second intelligent object page, the second control being at least used to trigger and display historical conversation content with the intelligent object. Accordingly, the page display method may further include:
displaying, on the first intelligent object page or the second intelligent object page and in response to a trigger operation on the second control, at least the historical conversation content with the intelligent object.

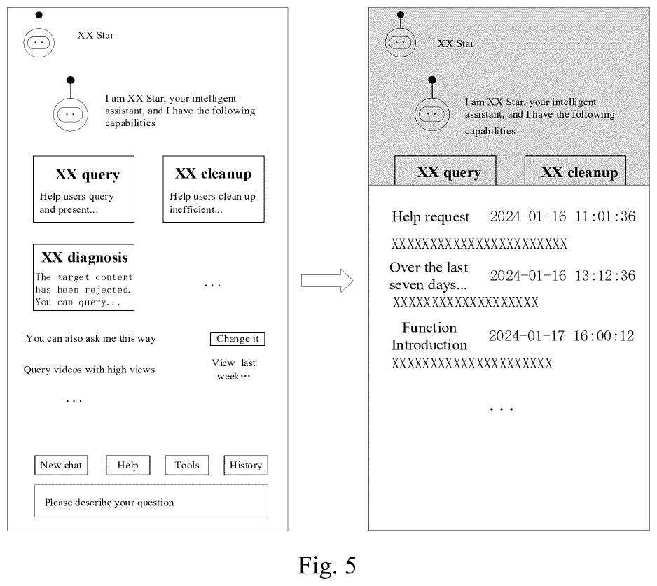

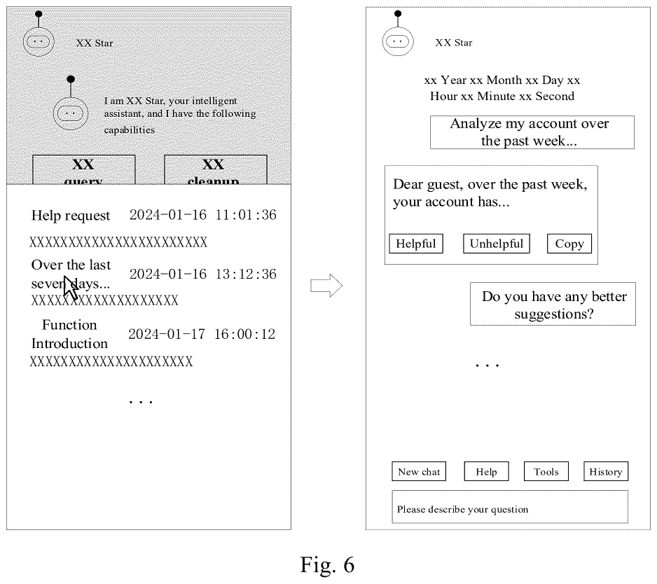

Exemplarily, continuing to refer to the above example, a second control “history” may be displayed above the text input box, and when the user triggers the second control “history” by clicking or other operations, the historical conversation content with the intelligent object is displayed, as shown in FIG. 5. When any historical conversation content is clicked, the historical conversation content may be displayed on the first intelligent object page, as shown in FIG. 6.

It should be understood that triggering and displaying the historical conversation content with the intelligent object by means of the control in this embodiment is only illustrative and does not constitute a limitation on the solution. In a possible implementation, the historical conversation content with the intelligent object may also be triggered and displayed by means of a conversation. For example, the historical conversation content with the intelligent object may be triggered and displayed by voice inputting “display historical conversation content” or by the user inputting natural language prompt text such as “historical conversation content” in the text input box.

With above method, the second control used to trigger and display the historical conversation content with the intelligent object may be displayed on the intelligent object page, and thus by triggering the second control, the historical conversation content with the intelligent object may be quickly displayed, so that the user can quickly review the previous conversation content when needed, which on one hand can help the user better understand the conversation content, and on the other hand can provide reference when the user needs to solve a problem similar to the previous problem, thereby improving the problem solving efficiency of the user and further improving the user experience.

In a possible implementation, the first intelligent object page and the second intelligent object page are further used to provide a conversation function with a human customer service agent, and the second control is used to trigger and display historical conversation content with the intelligent object and the human customer service agent. Accordingly, displaying, on the first intelligent object page or the second intelligent object page and in response to a trigger operation on the second control, at least the historical conversation content with the intelligent object may include:
classifying and displaying, in response to the trigger operation on the second control, first historical conversation content with the intelligent object and classifying and displaying second historical conversation content with the human customer service agent.

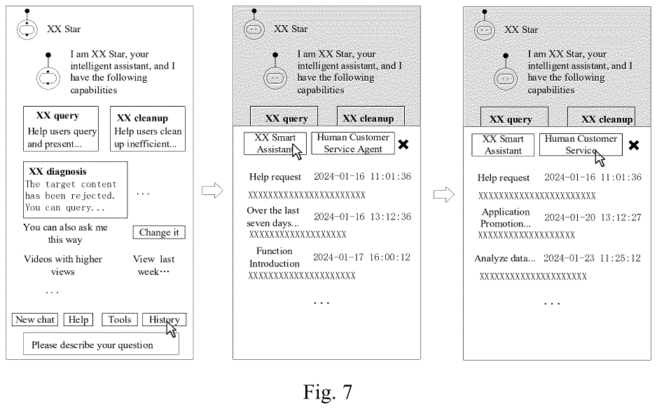

Exemplarily, continuing to refer to the above example, when the second control “history” is triggered by clicking or other operations, a conversation content viewing panel may be displayed, and the conversation content viewing panel may display a first viewing control “xx intelligent assistant” used to view the first historical conversation content and a second viewing control “human customer service agent” used to view the second historical conversation content. When the user triggers the first viewing control “xx intelligent assistant” by clicking or other operations, the first historical conversation content is displayed, and when the user triggers the second viewing control “human customer service agent” by clicking or other operations, the second historical conversation content is displayed, as shown in FIG. 7.

In the embodiment, when using the conversation function of the human customer service agent, the user and the human customer service agent may have a conversation in a voice manner, or may have a conversation in a text form, and of course, may also have a conversation in other forms, which is not limited in the embodiments of the present disclosure.

In the embodiment, when using the conversation function with the human customer service agent, a control used to have a conversation with the human customer service agent may be preset, and thus the user may have a conversation with the human customer service agent by triggering the control. Alternatively, when using the conversation function of the intelligent object, the conversation function of the human customer service agent may be triggered by prompt information input by the user, for example, the conversation function of the human customer service agent may be triggered by voice inputting “human customer service agent” or by the user inputting natural language prompt text such as “human customer service agent” in the text input box.

With above method, the second control used to trigger and display the historical conversation content with the intelligent object and the human customer service agent may be displayed on the intelligent object page, and thus by triggering the second control, the historical conversation content with the intelligent object and the human customer service agent may be quickly displayed, so that the user can quickly review the previous conversation content when needed, which on one hand can help the user better understand the conversation content, and on the other hand can provide reference when the user needs to solve a problem similar to the previous problem, thereby improving the problem solving efficiency of the user and further improving the user experience.

In a possible implementation, a third control is displayed on the first intelligent object page and the second intelligent object page, the third control being used to trigger and display function introduction information and/or operation tutorial information of the intelligent object. Accordingly, the page display method may further include:

displaying, on the first intelligent object page or the second intelligent object page and in response to a trigger operation on the third control, the function introduction information and/or the operation tutorial information of the intelligent object.

In the embodiment, the function explanation information and/or the operation tutorial information may be displayed in the form of pictures, or may be displayed in the form of text, or may be displayed in the form of videos, and of course may also be displayed in other forms, which is not limited in the embodiments of the present disclosure.

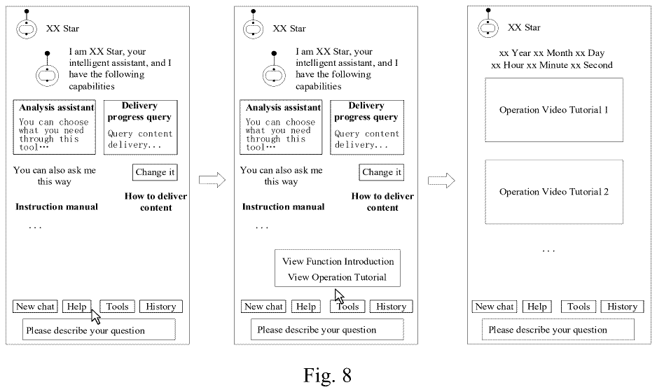

Exemplarily, as shown in FIG. 8, a third control “help” may be displayed above a text input box of the first intelligent object page, and when the user triggers the third control “help” by clicking or sliding, a selection page may be displayed, the selection page may display a fourth control “view function introduction” used to trigger the function introduction information of the intelligent object and a fifth control “view operation tutorial” used to trigger the operation tutorial information of the intelligent object, and when the fifth control “view operation tutorial” is triggered by clicking or sliding, one or more operation tutorial videos may be displayed in the first intelligent object page.

With above method, the third control used to view the function introduction information and/or the operation tutorial information of the intelligent object may be displayed on the intelligent object page, and thus by triggering the third control, the function introduction information and/or the operation tutorial information of the intelligent object may be quickly displayed, thereby helping the user to better understand and master the operation method of the intelligent object, making the intelligent object easier to use, and further improving the user experience.

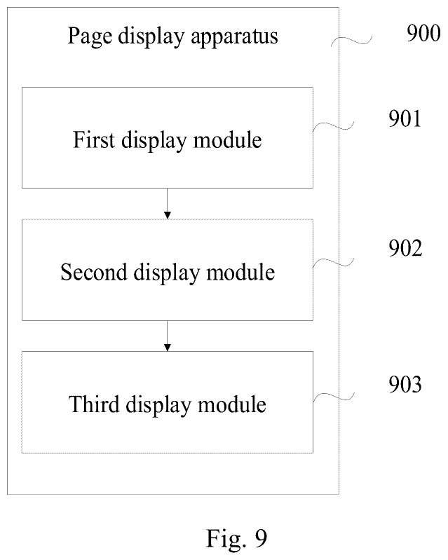

Based on the same concept, an embodiment of the present disclosure further provides a page display apparatus, as shown in FIG. 9, the page display apparatus 900 may include:
a first display module 901 configured to display an identification of an intelligent object on a page, the identification of the intelligent object being used to trigger an intelligent object page, the intelligent object page being at least used to provide an auxiliary function associated with the page by the intelligent object;
a second display module 902 configured to display a first intelligent object page in response to a first trigger operation on the identification of the intelligent object on the page; and
a third display module 903 configured to display a second intelligent object page in response to a second trigger operation on the identification of the intelligent object on the page, where display content of the first intelligent object page and display content of the second intelligent object page are different.

With above page display apparatus 900, it is possible to display the identification of the intelligent object on the page, and in response to different trigger operations on the identification of the intelligent object on the page, the intelligent object page may be displayed, and different display content may be displayed on the intelligent object page. Thus, the display content on the intelligent object page may be changed according to different trigger operations, to implement personalized scene adaptation, satisfy the needs of users in different scenes, and improve interaction efficiency and user experience. In addition, since the intelligent object page may also be used to provide the auxiliary function associated with the page, on one hand, the display content on the intelligent object page may be enriched, and on the other hand, the problem on the page may be quickly solved through the auxiliary function without frequent interaction with the intelligent object, thereby further improving interaction efficiency and user experience.

In a possible implementation, the page may include a first page and a second page, and accordingly, the second display module 902 may be configured to display the first intelligent object page in response to the first trigger operation on the identification of the intelligent object on the first page, and the third display module 903 may be configured to display the second intelligent object page in response to the second trigger operation on the identification of the intelligent object on the second page.

In a possible implementation, the first intelligent object page is displayed with a first auxiliary function associated with the first page and/or first text information for the user to select, and the second intelligent object page is displayed with a second auxiliary function associated with the second page and/or second text information for the user to select, where the first auxiliary function and the second auxiliary function are different, and/or the first text information and the second text information are different.

In a possible implementation, the second display module 902 may be configured to display the first intelligent object page in response to a first trigger operation of a first user on the identification of the intelligent object on the page; and the third display module 903 may be configured to display the second intelligent object page in response to a second trigger operation of a second user on the identification of the intelligent object on the page.

In a possible implementation, the first intelligent object page and the second intelligent object page are further used to provide a conversation function with the intelligent object, and a first control is displayed on the first intelligent object page and the second intelligent object page, the first control being used to trigger a new conversation with the intelligent object. Accordingly, the page display apparatus 900 may further include:
a fourth display module configured to, clear, on any of the first intelligent object page and the second intelligent object page and in response to a trigger operation on the first control, historical conversation content with the intelligent object, create a new conversation with the intelligent object, and display content that is displayed when a page is initially triggered.

In a possible implementation, the first intelligent object page and the second intelligent object page are further used to provide a conversation function with the intelligent object, and a second control is displayed on the first intelligent object page and the second intelligent object page, the second control being at least used to trigger and display historical conversation content with the intelligent object. Accordingly, the page display apparatus 900 may further include:
a fifth display module configured to, display, on the first intelligent object page or the second intelligent object page and in response to a trigger operation on the second control, at least the historical conversation content with the intelligent object.

In a possible implementation, the first intelligent object page and the second intelligent object page are further used to provide a conversation function with a human customer service agent, and the second control is used to trigger and display historical conversation content with the intelligent object and the human customer service agent. Accordingly, the fifth display module may also be configured to, in response to the trigger operation on the second control, classify and display first historical conversation content with the intelligent object and classify and display second historical conversation content with the human customer service agent.

In a possible implementation, a third control is displayed on the first intelligent object page and the second intelligent object page, the third control being used to trigger and display function introduction information and/or operation tutorial information of the intelligent object. Accordingly, the page display apparatus 900 may further include:
a sixth display module configured to, display, on the first intelligent object page or the second intelligent object page and in response to a trigger operation on the third control, the function introduction information and/or the operation tutorial information of the intelligent object.

Based on the same concept, an embodiment of the present disclosure further provides a computer-readable medium having a computer program stored thereon, where the computer program, when executed by a processing apparatus, performs the steps of any of the above page display methods.

Based on the same concept, an embodiment of the present disclosure further provides an electronic device, including:
a storage apparatus having a computer program stored thereon; and
a processing apparatus configured to execute the computer program in the storage apparatus to implement the steps of any of the above page display methods.

Based on the same concept, an embodiment of the present disclosure further provides a computer program product, including a computer program, where the computer program, when executed by a processor, implements the steps of any of the above page display methods.

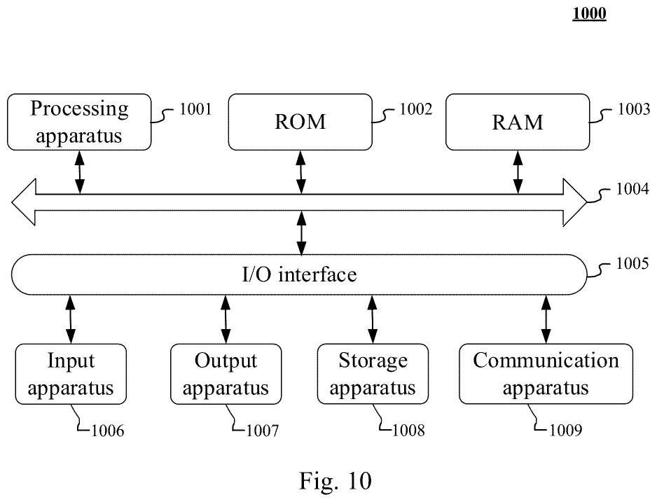

Reference is made to FIG. 10 below, which illustrates a schematic diagram of a structure of an electronic device 1000 suitable for implementing embodiments of the present disclosure. The terminal device in the embodiments of the present disclosure may include, but not limited to, mobile terminals such as a mobile phone, a laptop, a digital broadcast receiver, a PDA (personal digital assistant), a PAD (tablet computer), a PMP (portable multimedia player), a vehicle-mounted terminal (e.g., a vehicle-mounted navigation terminal), etc., and fixed terminals such as a digital TV, a desktop computer, etc. The electronic device shown in FIG. 10 is only an example, and should not impose any limitation on the function and scope of use of the embodiments of the present disclosure.

As shown in FIG. 10, the electronic device 1000 may include a processing apparatus (e.g., a central processing unit, a graphics processor, etc.) 1001, which may perform various appropriate actions and processing according to a program stored in a read-only memory (ROM) 1002 or a program loaded from a storage apparatus 1008 into a random access memory (RAM) 1003. Various programs and data necessary for the operation of the electronic device 1000 are also stored in the RAM 1003. The processing apparatus 1001, the ROM 1002 and the RAM 1003 are connected to each other through a bus 1004. An input/output (I/O) interface 1005 is also connected to the bus 1004.

Generally, the following apparatuses may be connected to the I/O interface 1005: an input apparatus 1006 including, for example, a touchscreen, a touchpad, a keyboard, a mouse, a camera, a microphone, an accelerometer, a gyroscope, etc.; an output apparatus 1007 including, for example, a liquid crystal display (LCD), a speaker, a vibrator, etc.; a storage apparatus 1008 including, for example, a magnetic tape, a hard disk, etc.; and a communication apparatus 1009. The communication apparatus 1009 may allow the electronic device 1000 to perform wireless or wired communication with other devices to exchange data. While FIG. 10 illustrates the electronic device 1000 having various apparatuses, it should be understood that not all of the illustrated apparatuses are necessarily implemented or provided. Alternatively, more or fewer apparatuses may be implemented or provided.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, the computer program including program codes for executing the method shown in the flowcharts. In such an embodiment, the computer program may be downloaded and installed from a network via the communication apparatus 1009, or installed from the storage apparatus 1008, or installed from the ROM 1002. When the computer program is executed by the processing apparatus 1001, above functions defined in the methods of the embodiments of the present disclosure are executed.

It should be noted that above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated in baseband or as a part of a carrier, and computer-readable program codes are carried in the data signal. The data signal propagated in this manner may be in various forms, including, but not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus or device. The program codes contained on the computer-readable medium may be transmitted by any suitable medium, including, but not limited to, an electrical wire, an optical cable. RF (radio frequency), etc., or any suitable combination thereof.

In some implementations, any currently known or future developed network protocol such as HTTP (HyperText Transfer Protocol) may be used to communicate, and may be interconnected with digital data communication (for example, a communication network) in any form or medium. Examples of communication networks include a local area network (“LAN”), a wide area network (“WAN”), the Internet (for example, the Internet), and a peer-to-peer network (for example, an ad hoc peer-to-peer network), as well as any currently known or future developed network.

The above computer-readable medium may be included in the above electronic device: or may exist alone without being assembled into the electronic device.

The above computer-readable medium carries one or more programs that, when executed by the electronic device, cause the electronic device to: display an identification of an intelligent object on a page, the identification of the intelligent object being used to trigger an intelligent object page, the intelligent object page being at least used to provide an auxiliary function associated with the page by the intelligent object; display a first intelligent object page in response to a first trigger operation on the identification of the intelligent object on the page; and display a second intelligent object page in response to a second trigger operation on the identification of the intelligent object on the page, where display content of the first intelligent object page and display content of the second intelligent object page are different.

The computer program codes for performing the operations of the present disclosure may be written in one or more programming languages or a combination thereof, where the above programming languages include, but are not limited to, object-oriented programming languages such as Java, Smalltalk, C++, and also include conventional procedural programming languages such as “C” language or similar programming languages. The program codes may be executed entirely on a user computer, partly on a user computer, as a stand-alone software package, partly on a user computer and partly on a remote computer, or entirely on a remote computer or server. In the case of the remote computer, the remote computer may be connected to the user computer through any kind of network, including a local area network (LAN) or a wide area network (WAN), or may be connected to an external computer (for example, connected via the Internet through an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that in some alternative implementations, the functions marked in the blocks may also occur in a different order than those marked in the drawings. For example, two blocks shown in succession may, in fact, be executed substantially concurrently, or the two blocks may sometimes be executed in a reverse order, depending on the functions involved. It should also be noted that each block in the block diagrams and/or flowcharts and a combination of blocks in the block diagrams and/or flowcharts may be implemented by a dedicated hardware-based system that performs the specified functions or operations, or may be implemented by a combination of dedicated hardware and computer instructions.

The modules involved in the embodiments of the present disclosure may be implemented in software or hardware. The name of a module does not constitute a limitation on the module itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the foregoing. More specific examples of the machine-readable storage medium include an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The above description is merely preferred embodiments of the present disclosure and an illustration of applied technical principles. Those skilled in the art should understand that the disclosure scope involved in the present disclosure is not limited to the technical solutions formed by the specific combination of the above technical features, and should also cover other technical solutions formed by any combination of the above technical features or equivalent features thereof without departing from the above disclosed concept. For example, the technical solutions formed by replacing the above features with technical features with similar functions disclosed in the present disclosure (but not limited to).

In addition, although various operations are depicted in a specific order, this should not be understood as requiring these operations to be performed in the specific order shown or in a sequential order. Under certain circumstances, multitasking and parallel processing may be advantageous. Similarly, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. Rather, the specific features and actions described above are merely exemplary forms for implementing the claims. Regarding the apparatus in the above embodiments, the specific manners in which the respective modules perform operations have been described in detail in the embodiments related to the method, and will not be described in detail here.

1. A page display method, comprising:
displaying an identification of an intelligent object on a page, the identification of the intelligent object being used to trigger an intelligent object page, the intelligent object page being at least used to provide an auxiliary function associated with the page by the intelligent object;
displaying a first intelligent object page in response to a first trigger operation on the identification of the intelligent object on the page; and
displaying a second intelligent object page in response to a second trigger operation on the identification of the intelligent object on the page, wherein display content of the first intelligent object page and display content of the second intelligent object page are different.

2. The page display method according to claim 1, wherein the page comprises a first page and a second page, and the displaying the first intelligent object page in response to the first trigger operation on the identification of the intelligent object on the page comprises: displaying the first intelligent object page in response to the first trigger operation on the identification of the intelligent object on the first page; and
wherein the displaying the second intelligent object page in response to the second trigger operation on the identification of the intelligent object on the page comprises: displaying the second intelligent object page in response to the second trigger operation on the identification of the intelligent object on the second page.

3. The page display method according to claim 2, wherein the first intelligent object page is displayed with at least one of a first auxiliary function associated with the first page and first text information for a user to select, and the second intelligent object page is displayed with at least one of a second auxiliary function associated with the second page and second text information for the user to select:
wherein the first auxiliary function and the second auxiliary function are different, and the first text information and the second text information are different: the first auxiliary function and the second auxiliary function are different: or the first text information and the second text information are different.

4. The page display method according to claim 1, wherein the displaying the first intelligent object page in response to the first trigger operation on the identification of the intelligent object on the page comprises: displaying the first intelligent object page in response to the first trigger operation of a first user on the identification of the intelligent object on the page; and
wherein the displaying the second intelligent object page in response to the second trigger operation on the identification of the intelligent object on the page comprises: displaying the second intelligent object page in response to the second trigger operation of a second user on the identification of the intelligent object on the page.

5. The page display method according to claim 1, wherein the first intelligent object page and the second intelligent object page are further used to provide a conversation function with the intelligent object, and a first control is displayed on the first intelligent object page and the second intelligent object page, the first control is used to trigger a new conversation with the intelligent object, and the page display method further comprises:
clearing, on any of the first intelligent object page and the second intelligent object page and in response to a trigger operation on the first control, historical conversation content with the intelligent object, creating a new conversation with the intelligent object, and displaying content that is displayed when a page is initially triggered.

6. The page display method according to claim 1, wherein the first intelligent object page and the second intelligent object page are further used to provide a conversation function with the intelligent object, and a second control is displayed on the first intelligent object page and the second intelligent object page, the second control is at least used to trigger and display historical conversation content with the intelligent object, and the page display method further comprises:
displaying, on the first intelligent object page or the second intelligent object page and in response to a trigger operation on the second control, at least the historical conversation content with the intelligent object.

7. The page display method according to claim 6, wherein the first intelligent object page and the second intelligent object page are further used to provide a conversation function with a human customer service agent, the second control is used to trigger and display historical conversation content with the intelligent object and the human customer service agent, and the displaying, on the first intelligent object page or the second intelligent object page and in response to a trigger operation on the second control, at least the historical conversation content with the intelligent object comprises:
classifying and displaying, in response to the trigger operation on the second control, first historical conversation content with the intelligent object, and classifying and displaying second historical conversation content with the human customer service agent.

8. The page display method according to claim 1, wherein a third control is displayed on the first intelligent object page and the second intelligent object page, the third control is used to trigger and display at least one of a group consisting of function introduction information and operation tutorial information of the intelligent object, and the page display method further comprises:
displaying, on the first intelligent object page or the second intelligent object page and in response to a trigger operation on the third control, at least one of the function introduction information and the operation tutorial information of the intelligent object.

9. A non-transitory computer-readable storage medium having a computer program stored thereon, wherein the computer program, when executed by a processing apparatus, performs steps of a page display method, the method comprising:
displaying an identification of an intelligent object on a page, the identification of the intelligent object being used to trigger an intelligent object page, the intelligent object page being at least used to provide an auxiliary function associated with the page by the intelligent object;
displaying a first intelligent object page in response to a first trigger operation on the identification of the intelligent object on the page; and
displaying a second intelligent object page in response to a second trigger operation on the identification of the intelligent object on the page, wherein display content of the first intelligent object page and display content of the second intelligent object page are different.

10. The storage medium according to claim 9, wherein the page comprises a first page and a second page, and the displaying the first intelligent object page in response to the first trigger operation on the identification of the intelligent object on the page comprises:
displaying the first intelligent object page in response to the first trigger operation on the identification of the intelligent object on the first page; and
wherein the displaying the second intelligent object page in response to the second trigger operation on the identification of the intelligent object on the page comprises:
displaying the second intelligent object page in response to the second trigger operation on the identification of the intelligent object on the second page.

11. The storage medium according to claim 10, wherein the first intelligent object page is displayed with at least one of a first auxiliary function associated with the first page and first text information for a user to select, and the second intelligent object page is displayed with at least one of a second auxiliary function associated with the second page and second text information for the user to select:
wherein the first auxiliary function and the second auxiliary function are different, and the first text information and the second text information are different: the first auxiliary function and the second auxiliary function are different: or the first text information and the second text information are different.

12. The storage medium according to claim 9, wherein the displaying the first intelligent object page in response to the first trigger operation on the identification of the intelligent object on the page comprises: displaying the first intelligent object page in response to the first trigger operation of a first user on the identification of the intelligent object on the page; and
wherein the displaying the second intelligent object page in response to the second trigger operation on the identification of the intelligent object on the page comprises: displaying the second intelligent object page in response to the second trigger operation of a second user on the identification of the intelligent object on the page.

13. The storage medium according to claim 9, wherein the first intelligent object page and the second intelligent object page are further used to provide a conversation function with the intelligent object, and a first control is displayed on the first intelligent object page and the second intelligent object page, the first control is used to trigger a new conversation with the intelligent object, and the page display method further comprises:
clearing, on any of the first intelligent object page and the second intelligent object page and in response to a trigger operation on the first control, historical conversation content with the intelligent object, creating a new conversation with the intelligent object, and displaying content that is displayed when a page is initially triggered.

14. The storage medium according to claim 9, wherein the first intelligent object page and the second intelligent object page are further used to provide a conversation function with the intelligent object, and a second control is displayed on the first intelligent object page and the second intelligent object page, the second control is at least used to trigger and display historical conversation content with the intelligent object, and the page display method further comprises:
displaying, on the first intelligent object page or the second intelligent object page and in response to a trigger operation on the second control, at least the historical conversation content with the intelligent object.

15. The storage medium according to claim 14, wherein the first intelligent object page and the second intelligent object page are further used to provide a conversation function with a human customer service agent, the second control is used to trigger and display historical conversation content with the intelligent object and the human customer service agent, and the displaying, on the first intelligent object page or the second intelligent object page and in response to a trigger operation on the second control, at least the historical conversation content with the intelligent object comprises:
classifying and displaying, in response to the trigger operation on the second control, first historical conversation content with the intelligent object, and classifying and displaying second historical conversation content with the human customer service agent.

16. The storage medium according to claim 9, wherein a third control is displayed on the first intelligent object page and the second intelligent object page, the third control is used to trigger and display at least one of a group consisting of function introduction information and operation tutorial information of the intelligent object, and the page display method further comprises:
displaying, on the first intelligent object page or the second intelligent object page and in response to a trigger operation on the third control, at least one of the function introduction information and the operation tutorial information of the intelligent object.

17. An electronic device, comprising:
a storage apparatus having a computer program stored thereon; and
a processing apparatus configured to execute the computer program in the storage apparatus to implement the steps of a page display method, the method comprising:
displaying an identification of an intelligent object on a page, the identification of the intelligent object being used to trigger an intelligent object page, the intelligent object page being at least used to provide an auxiliary function associated with the page by the intelligent object;
displaying a first intelligent object page in response to a first trigger operation on the identification of the intelligent object on the page; and
displaying a second intelligent object page in response to a second trigger operation on the identification of the intelligent object on the page, wherein display content of the first intelligent object page and display content of the second intelligent object page are different.

18. The electronic device according to claim 17, wherein the page comprises a first page and a second page, and the displaying the first intelligent object page in response to the first trigger operation on the identification of the intelligent object on the page comprises: displaying the first intelligent object page in response to the first trigger operation on the identification of the intelligent object on the first page; and
wherein the displaying the second intelligent object page in response to the second trigger operation on the identification of the intelligent object on the page comprises: displaying the second intelligent object page in response to the second trigger operation on the identification of the intelligent object on the second page.

19. The electronic device according to claim 18, wherein the first intelligent object page is displayed with at least one of a first auxiliary function associated with the first page and first text information for a user to select, and the second intelligent object page is displayed with at least one of a second auxiliary function associated with the second page and second text information for the user to select:
wherein the first auxiliary function and the second auxiliary function are different, and the first text information and the second text information are different: the first auxiliary function and the second auxiliary function are different: or the first text information and the second text information are different.

20. The electronic device according to claim 17, wherein the displaying the first intelligent object page in response to the first trigger operation on the identification of the intelligent object on the page comprises: displaying the first intelligent object page in response to the first trigger operation of a first user on the identification of the intelligent object on the page; and
wherein the displaying the second intelligent object page in response to the second trigger operation on the identification of the intelligent object on the page comprises: displaying the second intelligent object page in response to the second trigger operation of a second user on the identification of the intelligent object on the page.
